(19) United States
(12) Patent Application Publication
(10) Pub. No.: US 2001/0012991 A1
(43) Pub. Date: Aug. 9, 2001

(54) Apparatus, method and recording medium for translating documents

(75) Inventors: Kyoko Kimpara, Tokyo (JP); Mitsugu Miura, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION.

(21) Appl. No.: 09/734,195

(22) Filed: Dec. 12, 2000

(30) Foreign Application Priority Data
Dec. 13, 1999 (JP) 11-353677

(51) Int. Cl. G06F 17/28

(52) U.S. Cl. 704/5; 704/7; 704/2

(57) ABSTRACT

A translation server system is to be provided, which, even when a new hyperlink document is to be looked at, can minimize the troublesome work on the part of the user and reduce the communication cost by restraining unnecessary communication. A data acquisition unit 11 acquires a hyperlink document on the basis of translating instruction locational information F1 transmitted from a terminal apparatus 20, and an information separating unit 12 separates the hyperlink document acquired by the data acquisition unit 11 into a text T1 and non-text information T2. A translation unit 13 translates the text T1, an information conversion unit 14 adds translating instruction information contained in the translating instruction locational information F1 into the non-text information T2, and an information synthesizing unit 15 synthesizes the result of translation by the translation unit 13 and the result of conversion by the information conversion unit 14, and supplies the result of synthesis to the terminal apparatus 20.

### BACKGROUND OF THE INVENTION

1. Field of the Invention

The present invention relates to an apparatus, a method and storage medium for translating documents, and more particularly to an apparatus, a method and storage medium for translating documents associated with other documents by locational information (hereinafter to be referred to as hyperlink documents). In this specification, this apparatus will be referred to as a translation server.

2. Description of the Related Art

In recent years, along with the dramatic improvement in computerized processing by personal computers (PCs) and work stations among others together with the development of networks including the Internet, various digitized information is transmitted and received by computerized communication. Further, the enhanced processing capacity of computers has led to the advent of operating systems (OS) whose communication environment is well developed and, at the same time, browsing programs known as browsers, which operate on such an OS and are claimed to facilitate access to information, are offered at low prices or even free of charge. Over the networks, especially the Internet, various information is distributed across national borders. This is no less true of document data, whose contents are basically accessible by anybody in the world as they are distributed over the Internet.

On the Internet, companies, universities and others are presenting their respective home pages, which are written in either English or the respective official languages of the countries to which the presenting parties belong. The aforementioned browsers also facilitate access to these home pages, but if a user whose native language is not English accesses a home page written in English he would find it impossible to understand its contents either at all or at least immediately. Such a language barrier should be lowered as much as practicable in order to vitalize cultural or economic exchanges through the transmission and reception of information. This necessitates a translation apparatus.

FIG. 11 is a block diagram illustrating the configuration of a translation server system according to the prior art. The conventional translation server system is configured of a translation server 100, a terminal apparatus 200, such as a PC, operated by the user and a server apparatus 300 in which hyperlink documents are stored, all connected via a network. The translation server 100 consists of a data acquisition unit 110, an information separating unit 120, a translation unit 130 and an information synthesizing unit 140. A translating instruction application program 210 to instruct the translation server 100 to translate a document designated by locational information F100 is built into the into the terminal apparatus 200. A browser is also built into the terminal apparatus 200 to realize the translating instruction application program 210.

The translation server system illustrated in FIG. 11 operates as described below.

First the user designates to the browser built into the terminal apparatus 200 the URL of the translation server 100, and establishes connection to the translation server 100. Upon establishment of connection to the translation server 100, an input dialog box for entering the URL to be accessed is displayed on the terminal apparatus 200. The user designates in this input dialog box the URL to be accessed. The URL entered from the input dialog box is transmitted as locational information F100 to the data acquisition unit 110 of the server apparatus 100.

Upon receiving the locational information F100, the data acquisition unit 110 accesses the server apparatus 300 designated by this locational information F100, and acquires necessary information. Then, upon acquiring necessary information from the server apparatus 300, the data acquisition unit 110 stores that information into a cache memory and also transmits it to the terminal apparatus 200. This causes the contents of information at the user-designated URL to be displayed on the browser of the terminal apparatus 200. For instance, if the user has designated a URL having contents prepared in English, the contents will be displayed in English on the browser.

Next, as the user gives a translating instruction to the browser, which is the translating instruction application program 210, translating instruction F100 is transmitted from the terminal apparatus 200 to the server apparatus 100. Upon receiving this translating instruction F100, the data acquisition unit 110 supplies the contents stored in the cache memory to the information separating unit 12. The information separating unit 120 separates the information supplied from the data acquisition unit 110 into a text T100 and a non-text part T110, supplies the text T100 to the translation unit 130 and the non-text part T110 to the information synthesizing unit 14. The translation unit 130 processes the translation of the text T100 supplied from the information separating unit 120. For instance, if the text T100 is prepared in English, it is translated into Japanese and supplied to the information synthesizing unit 140.

The information synthesizing unit 140 synthesizes the translated text supplied from the translation unit 130 and the non-text part T110 supplied from the information separating unit 120, and supplies the synthesized information to the terminal apparatus 200 accessing the translation server 100. Generally, as a hyperlink document is diversely linked, and the user wishing to view the contents of the destination of any such link on the browser has to enter again the URL of the destination to the browser, and transmit it to the server apparatus 100 as locational information F100. If the contents need to be translated, a translating instruction F100 will have to be transmitted to the server apparatus 100.

However, this translation server system according to the prior art involves the problem that, even if the user selects the link in the translated document, the browser does not transmit locational information F100 to the translation server 100 to look at the contents of a new translated hyperlink document, only the document stored in a server designated by the locational information F100, i.e. untranslated document, is displayed on the browser, and translating that document would require issuance of a translating instruction F100 to the translation server 100 by means that the user gives a translating instruction to the browser, which is extremely troublesome and complex. Moreover, this extra work involves the further problem of causing unbearable trouble to the user because he has to endure it every time he looks at the contents of a new hyperlink document.

Furthermore, as the apparatus according to the prior art displays translated information only after once displaying the untranslated information on the browser and transmitting a translating instruction F110 to the translation server 100, the duration of connection is inevitably extended, resulting in an extra communication cost. This is a particularly serious problem for users in today's Japanese environment for communication, where connection to the Internet is usually established by dial-up. It may not seem to be a serious problem where an environment of sustained connection to the Internet is available, but in view of the finiteness of network resources wasteful communication should be eliminated wherever practicable.

### SUMMARY OF THE INVENTION

An object of the present invention is to provide a translation apparatus, a translation method and a storage medium on which a translation program is recorded for enabling the user to minimize his trouble and the cost of communication to be reduced by restraining unnecessary communication even when he is to look at a new hyperlink document.

According to an aspect of the present invention, there is provided an apparatus for translating documents, comprising: a data acquisition unit for acquiring from a server apparatus a document prepared in a first language; an information separating unit for separating the document acquired by the data acquisition unit into a translation-needing portion and a non-translation-needing portion; a translation unit for translating the translation-needing portion obtained by the information separating unit into a second language; an information conversion unit for converting the non-translation-needing portion obtained by the information separating unit, where the portion contains the locational information of any other document, into a version of the portion appended with translating instruction information for causing the data acquisition unit to recognize the need to translate the other document; and an information synthesizing unit for synthesizing the result of translation by the translation unit and that of conversion by the information conversion unit and supplying the result of synthesis to a terminal apparatus.

According to another aspect of the present invention, there is provided a method for translating documents, comprising: acquiring a document prepared in a first language from a server apparatus; separating the acquired document into a translation-needing portion and a non-translation-needing portion; translating the translation-needing portion into a second language; converting the non-translation-needing portion, where the portion contains the locational information of any other document, into a version of the portion appended with translating instruction information for recognizing the need to translate the other document; and synthesizing the result of translation and that of conversion and supplying the result of synthesis to a terminal apparatus.

According to still another aspect of the present invention, there is provided a storage medium recording thereon a program enabling a computer to execute: processing to acquire from a server apparatus a document prepared in a first language; processing to separate the acquired document into a translation-needing portion and a non-translation-needing portion; processing to translate the translation-needing portion into a second language; processing to convert the non-translation-needing portion, where the portion contains the locational information of any other document, into aversion of the portion appended with translating instruction information for recognizing the need to translate the other document; and processing to synthesize the result of translation and that of conversion and supply the result of synthesis to a terminal apparatus.

### BRIEF DESCRIPTION OF THE DRAWINGS

Other features and advantages of the present invention will become more apparent from the detailed description hereunder when taken in conjunction with the accompanying drawings, wherein:

FIG. 1 is a block diagram illustrating the configuration of a translation server system, which is a preferred embodiment of the invention;

FIG. 2 is a flow chart showing how the translation server system, which is the preferred embodiment of the invention, operates;

FIG. 3 illustrates an example of translating instruction locational information;

FIG. 4 illustrates an example of hyperlink document acquired by a data acquisition unit 11;

FIG. 5 illustrates an example of displaying of the hyperlink document shown in FIG. 4 on a browser;

FIG. 6 illustrates a text T1 separated by an information separating unit 12 where the hyperlink document is what is shown in FIG. 4;

FIG. 7 illustrates non-text information T2 separated by an information separating unit 12 where the hyperlink document is what is shown in FIG. 4;

FIG. 8 illustrates a result of translation of the text T1 shown in FIG. 6 by a translation unit 13;

FIG. 9 illustrates a result of conversion of the non-text information T2 shown in FIG. 7 by an information conversion unit 14;

FIG. 10 illustrates the contents of display on a browser after processing by a translation server 10; and

FIG. 11 is a block diagram of the configuration of a translation server system according to the prior art.

### DETAILED DESCRIPTION OF THE PREFERRED EMBODIMENTS

A translation server system, which is a preferred embodiment of the present invention will be described in detail below with reference to accompanying drawings.

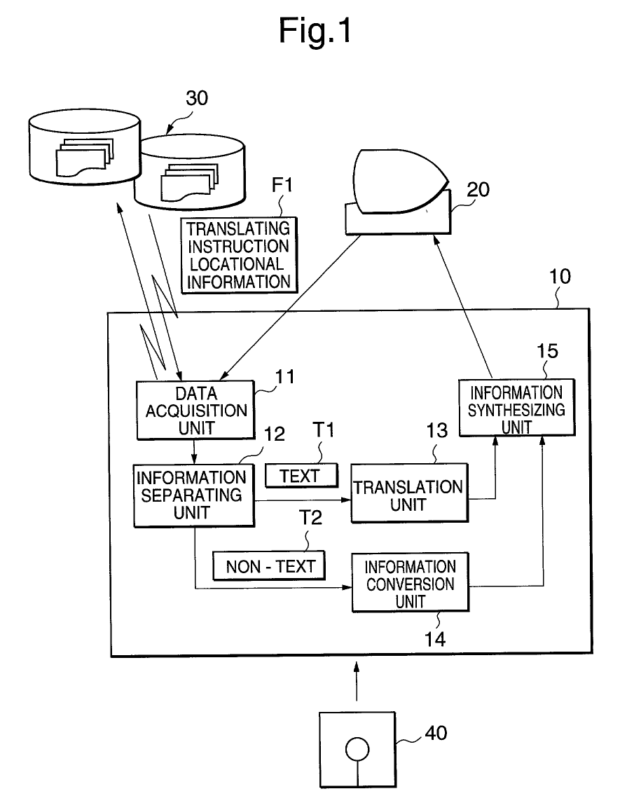

FIG. 1 is a block diagram illustrating the configuration of a translation server system, which is an embodiment of the invention. In FIG. 1, reference numeral 10 denotes a translation server; 20, a terminal apparatus such as a PC or a work station; and 30, a server apparatus in which hyperlink documents are stored. The translation server 10, the terminal apparatus 20 and the server apparatus 30 are connected via a network such as the Internet. In this embodiment, the functions of the translation server 10 may as well be realized by a program loaded from a storage medium 40 via a signal line. The storage medium 40 may be a magnetic disk, a semiconductor memory or any other suitable storage medium, and the program may be divided and each divided segment may be recorded on one or another of a plurality of grouped storage media.

The terminal apparatus 20 is mounted with a browsing program known as a browser to facilitate access to information, and supplies, at the instruction of the user, information F1 to instruct a server apparatus 10 to translate a document identified by pertinent locational information (hereinafter to be referred to as translating instruction locational information). This embodiment provides a system which, where the user transmits translating instruction locational information F1 by operating the terminal apparatus 20, translates a hyperlink document using the server apparatus 10 connected to a network.

The translation server 10 consists of a data acquisition unit 11, an information separating unit 12, a translation unit 13, an information conversion unit 14, and an information synthesizing unit 15. The data acquisition unit 11, when translating instruction locational information F1 has been transmitted from a browser provided on the terminal apparatus 20, acquires a document stored in the server apparatus 30 identified by locational information contained in the translating instruction locational information F1. The information separating unit 12 analyzes the document acquired by the data acquisition unit 11, separates it into a translation-needing text T1 and other information T2. The translation unit 13 translates into another language the translation-needing text T1 supplied from the information separating unit 12. If, for instance, the text T1 is prepared in Japanese, the translation unit 13 translates it into English.

The information conversion unit 14 converts locational information (hereinafter to be referred to as hyperlink) which associates a document contained in the non-text information T2 separated by the information separating unit 12 into translating instruction locational information F1, which is an instruction to translate a document designated by the locational information. This translating instruction locational information can be notified to the data acquisition unit 11 again as an instruction to translate a document. The information synthesizing unit 15 synthesizes the output result of the translation unit 14, i.e. the translated text T1, and the output result of the information conversion unit 14, i.e. non-text information containing translating instruction locational information, and supplies a new hyperlink document. The translation server 10 provided with the units so far described can consecutively translate newly displayed documents as well.

Next will be described the operation of the translation server system configured as described above, which is the preferred embodiment of the present invention.

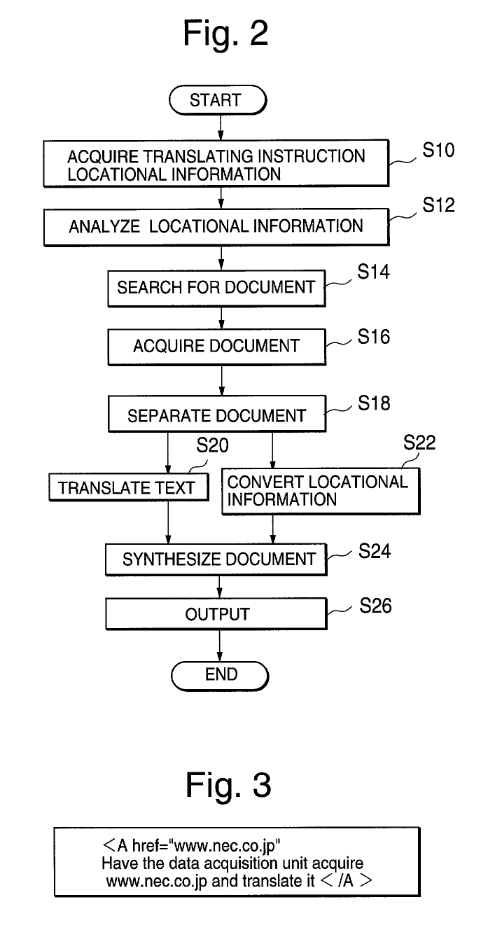

FIG. 2 is a flow chart showing how the translation server system, which is the embodiment of the invention, operates. FIG. 2 shows the processing from the time the translating instruction locational information F1 is transmitted from the terminal apparatus 20 to the translation server 10 until the displaying of a document designated by locational information contained in the translating instruction locational information F1 on the terminal apparatus 20. If the user requests access to a new document, the processing shown in FIG. 2 is repeated.

First, the user designates the URL of the translation server to the browser built into the terminal apparatus 20, and establishes connection to the translation server 10. Upon connection to the translation server 10, an input dialog box for entering the URL to be accessed and a dialog box for selecting the languages between which translation is to be done are displayed on the terminal apparatus 20. In this embodiment, for the sake of simplifying the description, a case in which translation is done from Japanese into English alone will be described.

For instance, if the user enters “http://www.nec.co.jp” into the input dialog box as the URL of the access destination, information shown in FIG. 3 is transmitted to the translation server 10 as the translating instruction locational information F1. FIG. 3 illustrates an example of translating instruction locational information. In FIG. 3, “www.nec.co. jp” is the locational information contained in the translating instruction locational information, and “Have the data acquisition unit acquire www.nec.co.jp and translate it” is the translating instruction information contained in the translating instruction locational information. Incidentally, the translating instruction information shown in FIG. 3 is nothing more than an example, but any sign that the server apparatus 10 can recognize as translating instruction information can be used.

The data acquisition unit 11, upon acquiring the translating instruction locational information F1 transmitted form the terminal apparatus 20 (step S10), analyzes the locational information contained in the translating instruction locational information F1 (step S12). If the translating instruction locational information F1 is what is shown in FIG. 3, the locational information is “www.nec.co.jp”. Upon completion of the analysis, the data acquisition unit 11 searches via a network the server apparatus 30 in which a hyperlink document designated by locational information in the translating instruction locational information (step S14), and acquires the designated hyperlink document (step S16).

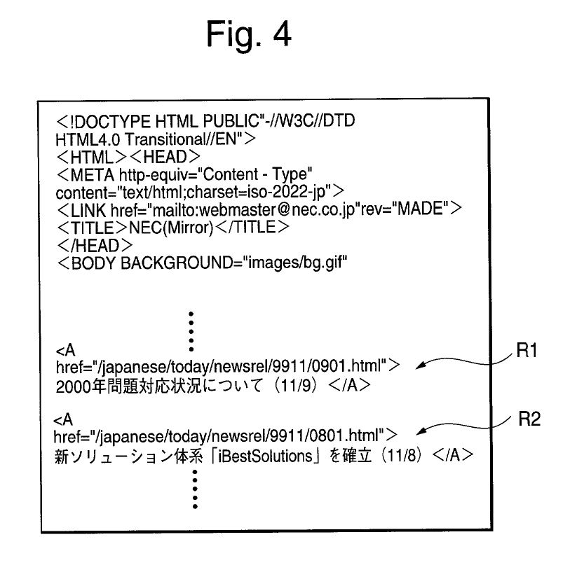

Here it is supposed that the data acquisition unit 11 acquires a hyperlink document such as the one shown in FIG. 4. A hyperlink document consists of a text appended with its layout information (so-called tag information), and that layout information includes the locational information items R1 and R2 of the associated document. Incidentally, since the hyperlink document here is supposed to be prepared in Japanese, the line immediately under each of locational information items R1 and R2 is stated a text in Japanese. The text under the locational information R1 means “About Y2K issue proof situation (11/9)”, and that under locational information R2 means “It establishes new solution system iBestSolutions (11/9)”.

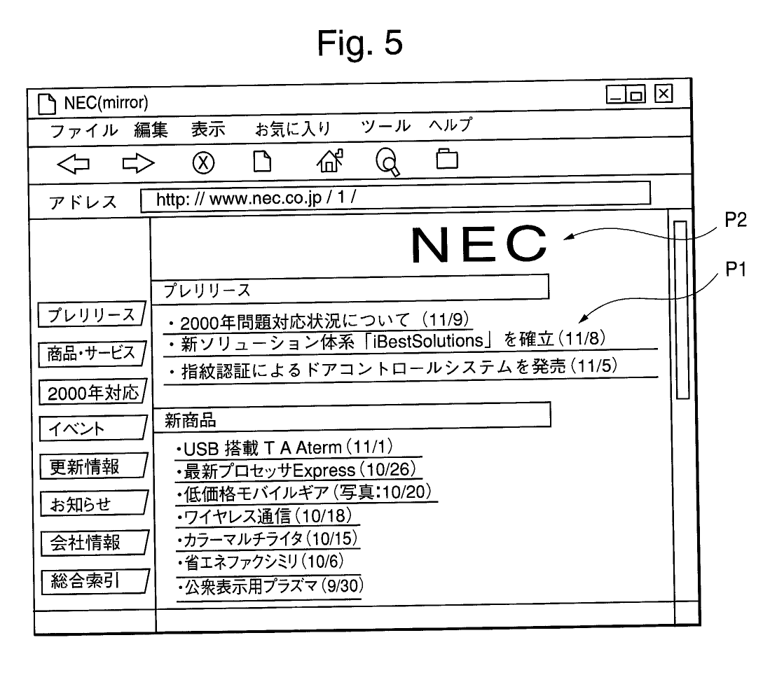

If the hyperlink document shown in FIG. 4 is displayed untranslated on the browser, it will look like what is shown in FIG. 5. This display includes portion p1 for instructing display of another document according to the aforementioned locational information items R1 and R2 and portion p2 for displaying an image according to visual locational information. Incidentally, the texts under locational information items R1 and R2 in FIG. 4 are displayed on the first and second lines, respectively, of portion pl.

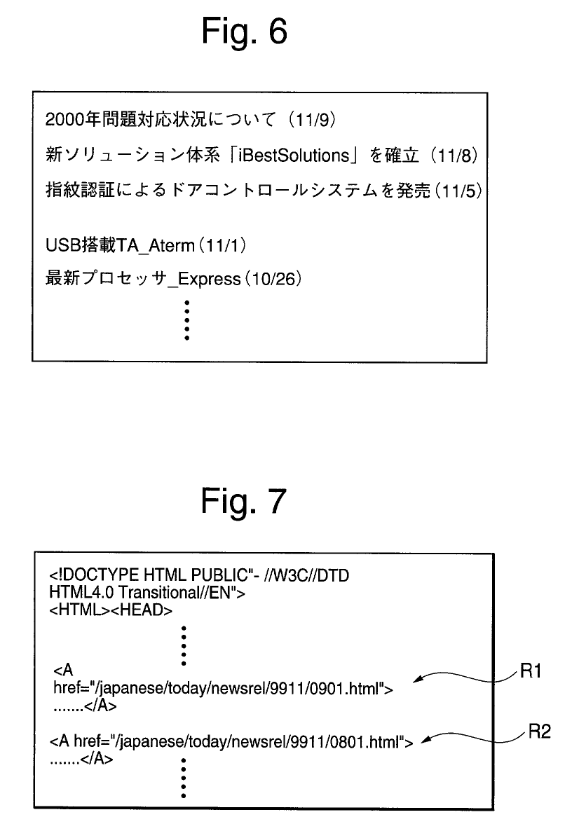

When the data acquisition unit 11 acquires a hyperlink document, the hyperlink document is supplied to the information separating unit 12. The information separating unit 12 analyzes the hyperlink document supplied from the data acquisition unit 11, and separates it into a translation-needing text and other information (step S18). FIG. 6 illustrates a text T1 separated by the information separating unit 12 where the hyperlink document is what is shown in FIG. 4, and FIG. 7 illustrates non-text information T2 separated by the information separating unit 12 where the hyperlink document is what is shown in FIG. 4.

As illustrated in FIG. 6, the text T1 consists of what is displayed on the browser in Japanese characters out of the items of information shown in FIG. 4. On the other hand, as illustrated in FIG. 7, non-text information T2 consists of tag information not displayed on the browser out of the items of information shown in FIG. 4, and includes the locational information R1 and R2 of the associated document shown in FIG. 4. The text T1 is supplied from the information separating unit 12 to the translation unit 13, while the non-text information T2 is supplied from the information separating unit 12 to the information conversion unit 14.

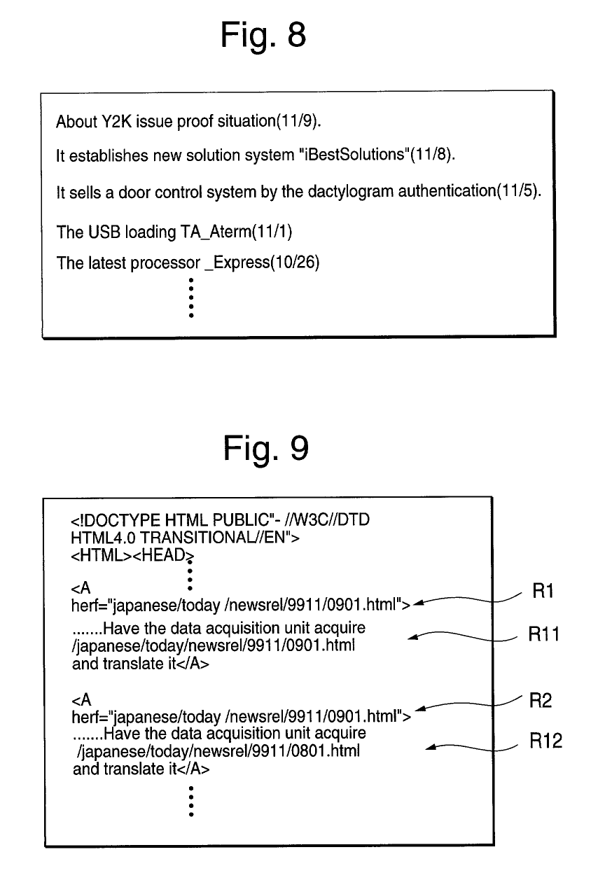

Upon entry of the text T1 into the translation unit 13, the translation unit 13 translates the entered text T1 (step S20). On the other hand, upon entry of the non-text information T2 into the information conversion unit 14, the information conversion unit 14 converts the locational information indicating the location of the hyperlink document out of the non-text information T2 into information that can be notified again to the data acquisition unit 11 as the translating instruction locational information F1 (step S22). FIG. 8 illustrates the result of translation of the text T1 shown in FIG. 6 by the translation unit 13, and FIG. 9, the result of conversion of the non-text information T2 shown in FIG. 7 by the information conversion unit 14.

As illustrated in FIG. 8, the text T1 in Japanese shown in FIG. 6 is translated into English. For example, the first line of the Japanese text is translated into an English phrase “About Y2K issue proof situation (11/9)”. On the other hand, as illustrated in FIG. 9, immediately under the locational information items R1 and R2, respectively, of the associated document are added information items R11 and R12 that can be notified to the data acquisition unit 11 as the translating instruction locational information F1. For instance, where the locational information R1 of the associated document is “/japanese/today/newsrel/9900/0901.html”, the information R11 that can be notified to the data acquisition unit 11 as the translating instruction locational information F1 is “Have the data acquisition unit acquire and translate /japanese/today/newsrel/9900/0901.html”. Incidentally, information that can be notified to the data acquisition unit 11 as the translating instruction locational information F1, like the aforementioned translating instruction locational information F1, may be any sign that the server apparatus 10 can recognize as translating instruction information.

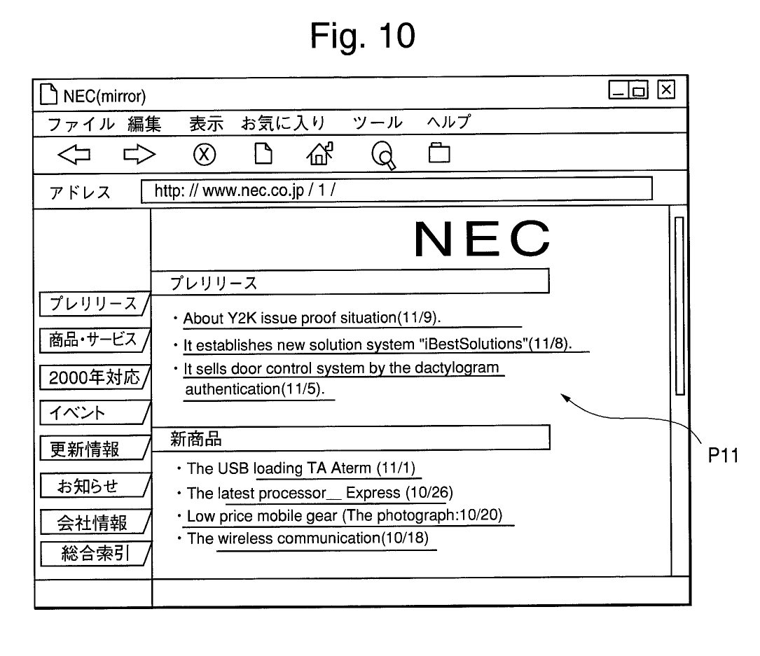

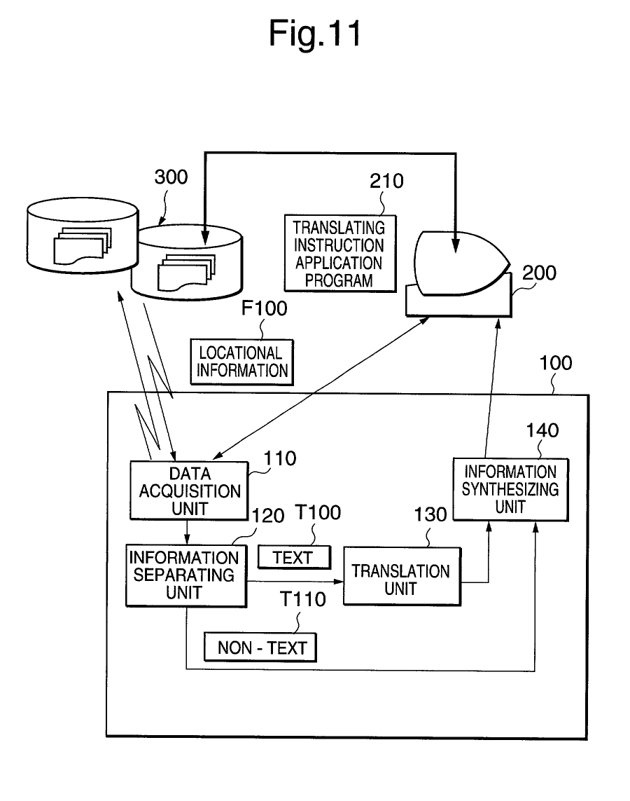

The result of translation of the text T1 by the translation unit 13 shown in FIG. 8 and the result of conversion of the non-text information T2 by the information conversion unit 14 shown in FIG. 9 are supplied to the information synthesizing unit 15. Upon entry of these result of translation and result of conversion, the information synthesizing unit 15 synthesizes them (step S22). In the above-described sequence of processing, the characters in the hyperlink document displayed on the browser as shown in FIG. 4 are translated, and the locational information of the associated document is appended with translating instruction information. The result of synthesis by the information synthesizing unit 15 is transmitted to the terminal apparatus 20, and what is illustrated in FIG. 10 is displayed on the browser of the terminal apparatus 20. FIG. 10 illustrates the contents of display on the browser after processing by the translation server 10.

As illustrated in FIG. 10, the display on the browser is in English. For instance, portion p1 for instructing the display of a document as shown in FIG. 5 will look like the portion to which sign p11 is assigned in FIG. 10. As hitherto described, in this embodiment, whereas the contents of display on the browser are made in a translated form by the translation server 10, the hyperlink document transmitted from the translation server 10 to the terminal apparatus 20 is appended with information items R11 and R12 that can be notified to the data acquisition unit 11 as the translating instruction locational information F1 as mentioned above. Therefore, if the user designates (clicks) the portion marked with sign p11 to look at the contents of the associated document, information indicating a translating instruction is transmitted to the translation server together with the locational information. Namely, the translating instruction locational information F1 is automatically transmitted. Accordingly, in this embodiment, translated contents are displayed as the user merely carries out a similarly to tracing the hyperlink document.

As hitherto described, according to the present invention, translating instruction information contained in the translating instruction locational information is added to the non-translation-needing information, and when locational information is transmitted from the terminal apparatus, the added translating instruction information is also transmitted, so that, even when a new hyperlink document is to be looked at, the result of translation is displayed by only taking the usual trouble of accessing a hyperlink document, there is the advantage of dispensing with the trouble of giving a translating instruction.

Furthermore, as the displayed contents of the hyperlink document are only translated ones, saving the user of the otherwise needed trouble of giving a translating instruction, the communication cost can be reduced by restraining unnecessary communication.

What is claimed is:

1. An apparatus for translating documents, comprising:
a data acquisition unit for acquiring from a server apparatus a document prepared in a first language;
an information separating unit for separating the document acquired by said data acquisition unit into a translation-needing portion and a non-translation-needing portion;
a translation unit for translating the translation-needing portion obtained by said information separating unit into a second language;
an information conversion unit for converting the non-translation-needing portion obtained by said information separating unit, where the portion contains the locational information of any other document, into a version of the portion appended with translating instruction information for causing said data acquisition unit to recognize the need to translate the other document; and
an information synthesizing unit for synthesizing the result of translation by said translation unit and that of conversion by said information conversion unit and supplying the result of synthesis to a terminal apparatus.

2. The apparatus, as claimed in claim 1, wherein:
said information conversion unit adds said translating instruction information to the locational information of said other document.

3. The apparatus, as claimed in claim 1, wherein:
when said data acquisition unit has received said translating instruction information, said information separating unit, said translation unit, said information conversion unit and said information synthesizing unit operate to translate that other document.

4. A method for translating documents, comprising:
acquiring a document prepared in a first language from a server apparatus;
separating said acquired document into a translation-needing portion and a non-translation-needing portion;
translating said translation-needing portion into a second language;
converting said non-translation-needing portion, where the portion contains the locational information of any other document, into a version of the portion appended with translating instruction information for recognizing the need to translate the other document; and
synthesizing the result of said translation and that of said conversion and supplying the result of synthesis to a terminal apparatus.

5. The method as claimed in claim 4, wherein:
said translating instruction information is added to the locational information of said other document in said conversion processing.

6. The method as claimed in claim 4, wherein:
when said data acquisition unit has received said translating instruction information, processing of said information separation, said translation, said conversion and said synthesis take place to translate that other document.

7. A storage medium recording thereon a program enabling a computer to execute:
processing to acquire a document prepared in a first language from a server apparatus;
processing to separate said acquired document into a translation-needing portion and a non-translation-needing portion;
processing to translate said translation-needing portion into a second language;
processing to convert said non-translation-needing portion, where the portion contains the locational information of any other document, into a version of the portion appended with translating instruction information for recognizing the need to translate the other document; and
processing to synthesize the result of said translation and that of said conversion and supplying the result of synthesis to a terminal apparatus.

8. The storage medium, as claimed in claim 7, wherein:
said program, in said conversion processing, causes said translating instruction information to be added to the locational information of said other document.

9. The storage medium as claimed in claim 7, wherein:
said program, when said translating instruction information has been received in said acquisition processing, causes that other document to be translated by causing said separation processing, said translation processing, said conversion processing and said synthesis processing to be executed.

10. A plurality of grouped storage media in which said program claimed in claim 7 is divided and each divided segment is recorded on one or another of said plurality of storage media.

11. A program embodied in electrical signals, said program enabling a computer to execute:
processing to acquire a document prepared in a first language from a server apparatus;
processing to separate said acquired document into a translation-needing portion and a non-translation-needing portion;
processing to translate said translation-needing portion into a second language;
processing to convert said non-translation-needing portion, where the portion contains the locational information of any other document, into a version of the portion appended with translating instruction information for recognizing the need to translate the other document; and
processing to synthesize the result of said translation and that of said conversion and supplying the result of synthesis to a terminal apparatus.

12. A program as claimed in claim 11, said program, in said conversion processing, causing said translating instruction information to be added to the locational information of said other document.

13. The program as claimed in claim 11, said program, when said translating instruction information has been received in said acquisition processing, further enabling the computer to execute translation of that other document by executing said separation processing, said translation processing, said conversion processing and said synthesis processing.
